(19) United States
(12) Patent Application Publication
(10) Pub. No.: US 2006/0238724 A1
(43) Pub. Date: Oct. 26, 2006

(54) Portable projection device

(75) Inventor: Kumar Kirti Trivedi, Maharashtra (IN)

Correspondence Address: KUSNER & JAFFE;HIGHLAND PLACE SUITE 310, 6151 WILSON MILLS ROAD, HIGHLAND HEIGHTS, OH, 44143, US

(73) Assignee: IL & FS Education & Technology Services Ltd.

(21) Appl. No.: 10/553,680

(22) PCT Filed: Aug. 11, 2003
(86) PCT No.: PCT/IN03/00268

§ 371 Date: Oct. 17, 2005

(30) Foreign Application Priority Data
May 23, 2003 (IN) 527/MUM/2003

(51) Int. Cl. G03B 23/00; G03B 21/22

(52) U.S. Cl. 353/119; 353/25

(57) ABSTRACT

The invention discloses a portable integrated electronic device for community learning, data transmission, entertainment and public governance which comprises a housing that accommodates a plurality of sub-assemblies. The sub-assemblies include a projector for projecting video and digital data into a predetermined ultra large size image over a surface external to the housing, a means for recording, reproducing and storing audio, video and/or digital data onto and/or from an external disk and an internal storage unit, a computational circuit for receiving and processing data input through an input device and adapted to be connected to a network and a television tuner card adapted to receive a plurality of television signal data. The sub-assemblies are in preconnected relationship with each other such that the sub-assemblies are operated by ON-OFF of a single button and the device becomes extremely compact, portable and easy to use.

### FIELD OF INVENTION

The present invention relates to the field of electronic devices and more specifically to a portable integrated multimedia electronic device built on convergence technology, particularly for use in, but not limited to receipt, storage and processing of digital and/or analog signals from satellites, broadcasts, telecasts, recording means and for ultra-large size display of images, for community use in the areas of education, shared learning, emergency and disaster handling, community awareness, promotional and publicity campaigns, public governance, entertainment, internet, broadcast access and so on.

### BACKGROUND ART

In the current economic and social scenario, there exists widespread awareness of and demand for multi-media content and its receipt, storage, processing, transmission and display on a community level. Various communities which seek and need the aforesaid include families, schooling communities, village councils and gatherings, public governance officials, investor communities, members, governing bodies, boards and councils of public bodies, communities, public and private enterprises and the like.

Current technology requires use of several different, complex and expensive electronic devices and systems for the fulfillment of each of the aforesaid requirements for any or all of the said communities. Currently, the products available for such purposes include multi-media computers, television sets, large format electronic display devices, audio players, VCD players, DVD players, game stations, projectors and special projection screens. Each of these products seeks to address one or more of the stated community requirements. Some of such products are:
a). Large field of view device for community uses.
b). Superwide angle lens for larger images.
c). Mobile entertainment systems combining projector, DVD player and hard disk drive.
d). Hyperformance home theatres.
e). Devices for connecting and using multiple products in conjunction.
f). Combination of multimedia computer and television.

Summarized below are descriptions of such products in the prior art which seek to satisfy one or more of the aforesaid community requirements:

a). Large Field of View Device for Community Uses

One such attempt to provide a large field of view for community presentation is disclosed in U.S. Pat. No. 6,042,238 which teaches an invention on an image projection display system for use in large field-of-view presentation, comprising a fold-mirror image arrangement and a plurality of projection devices. The use of this system is limited to simulation, leisure, computer aided design or visualization where multi-channel displays are to be used to immerse the observer to some degree in an alternative environment. This system highlights the difficulties inherent in providing large format displays of images at affordable prices.

b). Superwide Angle Lens for Larger Images

Another known device uses a superwide angle lens which projects a 60 inch image at a distance of 1.5 meters and a wider 100 inch image at a distance of 2.4 meters. [See the Hitachi website at www.hitachi.com for multimedia mobile LCD projector model CP X275].

c). Mobile Entertainment Systems Combining Projector, DVD Player and Hard Disk Drive

The REX mobile entertainment system—Bronze which won the Australian Design Award [see the Australian design awards website at designaward.com.au/ADA/0101/STUDENT%2-DESIGN/610/6101 features a combination of 3 currently available products, an ultra-portable projector, a portable DVD [digital video disc ] player, and a portable hard disk drive. But the system is not suitable for community use because it lacks a portable integration of computing, TV viewing, and interactive functions and the simplicity of operation required for community use.

d). Hyperformance Home Theatres

The HT-400 Series Home Theatre PC from Hyperformance Solutions [see www.hyperformancesolutions.com/HTPC/HT-400.htm] provides the functions of a VCR, CD player, DVD player, video scaler, video de-interlacer and personal computer in one unit which connects to the home TV. Apart from being relatively expensive, it presents many disadvantages as regards community usage.
e). Devices for connecting and using multiple products in conjunction The U.S. Pat. No. 6,522,419 granted to Ko Yoonyang features a single device to which various input and output devices can be conveniently and easily attached. However, the teachings of [symbol] this U.S. Pat. No. 6,522,419 suffer from the following drawbacks and disadvantages.

1) The device as disclosed in the U.S. Pat. No. 6,522,419 is an aggregation of known sub-assemblies which is not sufficiently user-friendly as many connections have to be made in the front portion of the device for various input and output devices, and also the device summons on the part of the user, familiarity and knowledge of different types of connectors and cables, which cannot be expected and assumed to be available with new users, particularly in rural areas in developing countries where technology percolation is low.

2) The device involves external connection of various input and output devices and hence does not provide a portable integrated system; hence it is susceptible to damage, loss or vandalism.

3) The display of images is limited to large format electronic displays or the use of a separate projector for projecting the images of the output devices, which have inherent display size limitations.

4) The device is relatively expensive to procure and operate and is likely to be beyond the reach of most rural communities in India and other developing countries.

5) The device requires a special controller which may be difficult for rural and uneducated persons to operate.

6) Since the device requires a multiplicity of input and output devices the use of several voltage stabilizing devices and uninterrupted power supply devices would become indispensable in rural India and other locations where power supply is not reliable and steady, leading to additional complexity and overall cost increase of the device.

7) The device relies on an exclusive operating system and main program installed on a chip which limits the options for upgrading and also increases the costs of up gradation.

8) The device needs a specially devised “Integrated environmental central processing unit” in addition to the central processing units in some of the connected devices.

9) The device does not provide for a ‘single’ button start-up function.

f). Combination of Multimedia Computer and Television

A further attempt to provide an integrated electronic device is a combination of multi-media computer and television apparatus disclosed in US Patent application publication Nos. 20020050083 and 20020021420 by M/s. Zarelius Gister and Yaniv Svi respectively. The above devices combine two expensive systems to provide a choice of displays of computer (data) signals or TV broadcast signals but are limited in their displays to the size of large format TV sets, which inherently limit their use to families. An audience of, say, 50 to 100 people would have difficulty in using such a device.

### SUMMARY OF PRIOR ART

From the foregoing discussion with regard to the prior art devices, and from an overall perspective, all the devices mentioned above:

(i) Are susceptible to damage, loss or vandalizing in community use (ii) Present formidable cultural and technological barriers to new users;

(iii) Present technological and budgetary challenges for up-gradation, maintenance and obsolescence mitigation.

Apart from the above drawbacks, the above devices require large storage and usage spaces, peripheral and auxiliary devices and facilities including temperature controls, dust controls and security.

Therefore, there has been a need for development of a portable integrated-electronic device which combines multitude of functions as discussed above for use in receipt, storage and processing of digital and/or analog signals from satellites, broadcasts, telecasts, recording means and for ultra-large size display of images, for community use in the areas of education, shared learning, emergency and disaster handling, community awareness, promotional and publicity campaigns, public governance, entertainment, internet and broadcast access and so on.

### OBJECTS OF THE INVENTION

Accordingly, the objects and advantages of the present invention are set out herein below:

1) An object of the present invention is to provide a portable integrated electronic device for community learning, data transmission, entertainment and public governance wherein the device integrates the functions of an Internet enabled multi-media computer, television, audio player, VCD player, DVD player, game station and a data projector in a single portable housing.

2) An object of the present invention is to provide a portable integrated electronic device for community learning, data transmission, entertainment and public governance wherein the device has all the components of various sub-assemblies pre-connected and configured so that the complicated process of connecting various sub-assemblies by user, is substantially eliminated.

3) Yet, another object of the present invention is to provide a portable integrated electronic device for community learning, data transmission, entertainment and public governance wherein due to the preconnected arrangement of the sub-assemblies, the device enables extremely easy use, as the user has to press only one button to switch on all the functions of the device which can be easily controlled and operated using a single remote control device.

4) Yet, another object of the present invention is to provide a portable integrated electronic device for community learning, data transmission, entertainment and public governance wherein the device combines various kinds of data sources inside one portable common housing (box) and allows teaching more creatively as users have simultaneous access to various kinds of resources such as text, audio, video processing and applications, which can be used when needed to make teaching more interesting and interactive.

5) Another object of the present invention is to provide a portable integrated electronic device for community learning, data transmission, entertainment and public governance wherein by making the data projector an integral part of the device, the device enables projecting a large image anywhere on any plain surface or wall without the requirement of a special screen or devices for viewing a large projected image.

6) Another object of the present invention is to provide a portable integrated electronic device for community learning, data transmission, entertainment and public governance wherein the device could be used in large groups or community situations whereby the same information can be shared by and explained to a large audience, leading to more efficient and effective learning and interactive presentation of information in various forms.

7) Another object of the present invention is to provide a portable integrated electronic device for community learning, data transmission, entertainment and public governance wherein the device is conceived as a combination of state-of-the-art components and sub-assemblies, with a modular design which allows upgrading of components as new technologies appear, so that the device keeps pace with the developments in technologies; and always presents the best combination of features at a given time, integrated in an efficient combination.

8) Yet another object of the present invention is to provide a portable integrated electronic device for community learning, data transmission, entertainment and public governance wherein the device is compact in size thereby allowing it to be fitted in one corner of the community room, discussion room or classroom and thereby substantially letting the center table or the main space free for other productive uses.

9) As a result of the combination of the functions of an internet enabled multimedia computer with TV, Audio/VCD/DVD player, internal hard disk and data projector in one single, portable device, a number of advantages accrue from the synergy of the combination which are not available when the individual products are used alone.

The advantages of synergy resulting from the combination of functions in the present invention as compared to separate products are listed below:

As Audio Player

The combination of hard disk storage with an audio player eliminates the need for storage of audio content on separate media (CDs/cassettes etc.) as such content can be sorted on the internal hard disk. By having all the audio content on the internal hard disk the need to separately protect and store safely a collection of CDs and Cassettes is eliminated.

The combination of audio CD player with the computer permits all the audio content to be catalogued, ordered and stored in various combinations, and played immediately at will through software search. This saves the time required to search and play the desired content.

The combination of audio player with the internal hard disk storage of all audio content eliminates the need for physically inserting different CDs to play such CDs; and any audio content on the hard disk can be selected and played using the remote control device.

The combination of audio player with a large format data projector and computer allows any music to be played along with dynamic visuals on the large screen, through the various media players available as software on the computer. Hearing and seeing the music simultaneously on the large screen provides a new audio-visual experience for the music, as compared to conventional audio players.

As a Large Format Television

The device gives large format television viewing in a size up to 300 inches, which is much larger than the commercially available large format plasma or projection television

The device occupies very little space as compared to the huge bulk of the large format TVs. It can be kept on a shelf on the wall, so that the complete floor space is free, and results in considerable space saving.

The combination of TV tuner and multi-media projector allows users to vary the size of the projected image depending on space availability; which is not possible with large format TVs, which have a fixed screen size and enable viewing in one size only.

As the image is projected on any plain surface or wall, no special electronic display devices such as plasma displays or projector screens are required to be installed.

The projected image is the flattest possible without any thickness or weight, and disappears when there is no projection, thus eliminating the need to protect an expensive display device.

The small size of the device according to the present invention allows the device to be locked away securely when not in use, thus making it easy to protect—which is an important advantage in community use situations.

As a DVD/VCD Player

The combination of DVD/VCD player with the data projector allows DVD/VCD content to be displayed in ultra large sizes of about 300 inches, providing movie theatre experience, which is much superior as compared to the large format projection TVs or plasma displays.

Preferred content can be stored on the hard disk enabling it to be played at will from a distance without having to insert individual DVDs/VCDs.

As a Gaming Station.

The combination of the computer and projector in one unit allows games to be displayed in ultra-large size, thus providing an enhanced enveloping viewing/participatory experience while playing games. Typical genres of games such as Car and Motorcycle races, Action, Space Adventure, Thrillers all provide heightened experience when played in ultra-large size.

As a Multimedia Internet computer

The combination of projector and the computer in one unit allows internet and multimedia content to be shared by a large audience, allowing participatory viewing by a community of users. Group viewing in large size enables more comfortable viewing of the content together with family and friends, such as from the living room sofa or the bed; as compared to viewing on the small computer screen where one has to sit upright close to the computer.

New Possibilities

A large number of new use possibilities emerge because of the small size, portability and the ultra large projected image. Some of these are listed below:

The devices of the invention will be the only piece of equipment required for showing content to a large group of people; reducing the investment required to equip an AV [audio-visual] room for all educational situations such as schools, coaching classes, training centres, seminars , community centres etc.; thus making possible emergence of many such group learning centres at low costs. By common explanation to a large audience, substantial time and effort savings will result by not having to repeat the same content or message to smaller groups repeatedly.

The low investment required will allow opening of small media centres/video theatres; thus resulting in new business opportunities for the small entrepreneurs.

Being a single portable product, which can be rented easily, it will develop a rental business opportunity for the product.

By carrying it in a vehicle, and drawing power from the battery of the vehicle; the device could function as a mobile device for promotion and awareness programmes in the remotest parts of countries and provinces where there may be no electricity supply.

By attaching a web-camera, the device will allow live video-conferencing in the remotest areas, thus allowing better management of disaster situations etc., by allowing two sided live exchange of images and conversation. The video-conferencing in remote areas will also facilitate e-governance to better monitor and govern the situation in the field by direct viewing from the seat of governance.

Further objects and advantages become apparent from a consideration of the drawings and the ensuing descriptions.

### BRIEF SUMMARY OF THE INVENTION

The invention is a portable integrated electronic device, comprising 6 major sub-assembles, providing all the functions of an internet enabled multi-media computer; television, ultra-large image display, audio player, VCD player, DVD player, game station and a data projector in one single portable box. All components of various sub-assemblies are pre-connected and configured; so that the complicated process of connecting various different products has been eliminated. The device is extremely easy to use, as the user has to press only one button to switch on all the functions of the product, which can be easily controlled using a single remote control. The combination of various kinds of data sources inside one common box, allows access to various kinds of resources: text, audio, video, processing, and applications, which can be used when needed to make teaching, sharing, processing and display of content more interesting and interactive.

By making the data projector an integral part of the product, a large image can be projected anywhere on any plain surface or wall. No special screen or devices are needed for seeing the large projected image.

The large image allows the product to be used in large groups or community situations; whereby the same information can be shared by and explained to a large audience, leading to a more efficient and effective learning and interaction situation.

The low investment required will allow opening of small media centers/video theatres; thus resulting in new business opportunities for the small entrepreneur.

Being a single portable product, which can be rented easily, it will develop a rental business opportunity for the product.

By carrying it in a vehicle, and drawing power from the battery of the vehicle; it would function as a mobile device for promotion and awareness program in the remotest parts where there may be no electricity supply.

By attaching a web-camera, it will allow live video-conferencing in the remotest areas, thus allowing better management of disaster situations etc., by allowing two sided live exchange of images and conversation. The video-conferencing in remote areas will also facilitate e-governance to better monitor the situation in field by direct viewing from the seat of governance.

Further objects and advantages will be apparent from a consideration of the drawings and the ensuing description.

In sum, the present invention is a portable integrated electronic device for receipt, storage, processing and transmission of multi-media signals and ultra large size display of images, for education, entertainment, shared community use, governance and social interaction and integration for various communities.

A more detailed explanation of the invention is provided in the following description and appended claims taken in conjunction with the accompanying drawings.

### BRIEF DESCRIPTION OF DRAWINGS

To complement the description that is being given and in order to promote a better understanding of the characteristics of the invention in accordance with a practical embodiment of the same and as an integral part of the said description a set of drawings accompany it in which, in an illustrative and non-restrictive way, the following are represented:

FIG. 1 is an overall external view of the integrated electronic device according to the present invention.

FIG. 2 is a front elevation of the device according to the present invention showing the overall arrangement and the interface presented to the user for using the device.

FIG. 3 is a side elevation of the device showing the configuration with the projector module on top and the data module below, with integrated speakers, according to the present invention.

FIG. 4 is an overall external view of the rear side of the device according to the present invention.

FIG. 5 is a schematic arrangement of the various sub-assemblies inside the device for the configuration with the projector module on top and the data module below according to the present invention.

FIG. 6A shows the device with the projector module and the data module kept side by side according to one embodiment of the present invention.

FIG. 6B shows the device with the projector module and data module arranged according to another embodiment of the present invention.

FIG. 7 is an overall external view of the device in a compact, ultra-portable form using miniature components.

FIG. 8 is an overall schematic view of a preferred form of the single remote control for use with the device.

### DETAILED DESCRIPTION OF THE INVENTION

A detailed description of the preferred embodiments and best modes for practicing the invention are described herein.

The present invention discloses a portable integrated electronic device for use in community learning, data transmission, entertainment and public governance.

The device may also be used effectively in emergency and disaster handling, awareness creation, product promotion, advertisement, entertainment; internet broadcast access and a variety of purposes.

The integrated electronic device (hereinafter referred to as device) according to the present invention comprises a housing which accommodates a plurality of sub-assemblies which are described in detail in the further part of this description.

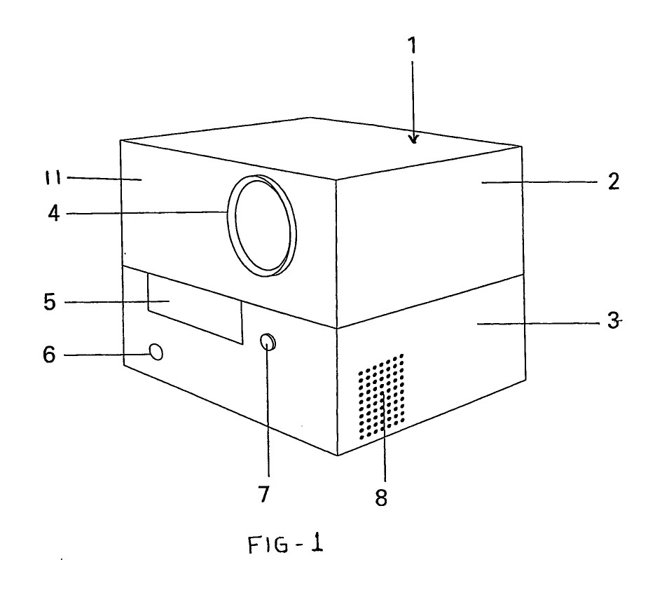

FIG. 1. In the embodiment shown, the device comprises a portable housing (1) which is easy to carry by hand from one location to another for community use. The housing (1) may be made of a material such as metal, alloy or composite material which is preferably used for housing material of conventional electronic devices.

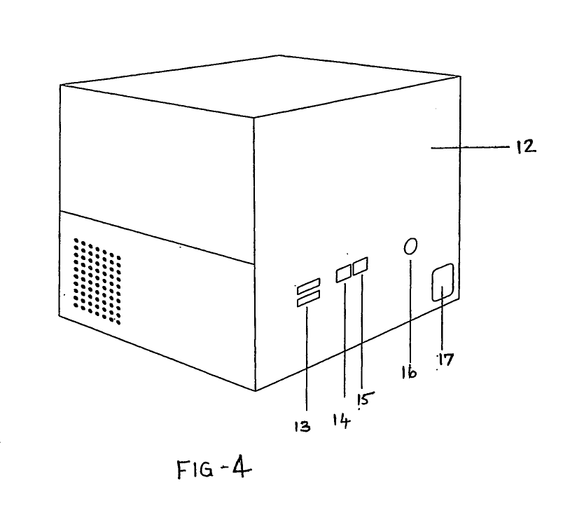

Preferably, the housing (1) has a box shape comprising a front panel (II) and a rear panel (12) (see FIG. 4).

Alternatively, the housing (1) may be configured to have any size, shape and ergonomics so as to be portable and enable carrying by hand from one location to another especially for community purposes.

This invention also contemplates a housing which may be temporarily or permanently fixed at a specific location in places such as railway stations, community halls, event halls, parks and other public and private establishments for addressing a community of people and which may be carried by hand or by suitable carrier vehicles such as trolleys, carts, trucks etc.

The sub-assemblies include:

(i). an apparatus for projecting video and digital data into a predetermined ultra large size image over a surface external to the housing;

(ii) an apparatus for recording, reproducing and storing audio, video and/or digital data onto and/or from an external disk and an internal storage unit;

(iii). a computational circuit for receiving and processing data input through an input device and adapted for connection onto a network; and

(iv). a television tuner card adapted for receiving a plurality of television signal data.

The sub-assemblies are configured in preconnected relationship with each other whereby the device is compact and easy to use.

The term “preconnected” is used herein in this application to state that the device has all the components of various sub-assemblies internally connected and configured such that the user has to press only one button to switch ON all the functions of the device thereby eliminating the complicated process of connecting various sub-assemblies by user, enabling extreme ease of use and operation by a single remote control device.

The sub-assemblies may be grouped into one or more modules within the housing (1) or may be individually housed without such modular arrangement.

In a preferred embodiment, the sub-assemblies (ii), (iii) and (iv) are grouped into one module hereinafter referred to as a data module (3) and the sub-assembly (i) is configured as a separate module hereinafter referred to as a projector module (2).

The projector module (2) projects video and digital data into a predetermined ultra large size image over a surface external to the housing (1). The video data may be for example data such as that from cable, satellite or broadcast television or from video compact discs or digital video discs and digital data may be data such as a text information, graphics, or visual output of various application software programs. The size of the display is suitable for community use and preferably is in the range of 21 inches to 300 inches when diagonally measured.

In one embodiment, a combo-drive unit (5) is incorporated for recording, reproducing and storing audio, video and/or digital data onto and/or from an external disk and an internal storage unit.

The combo-drive unit (5) may include a Digital Video Disk (DVD) Player, Video Compact Disk (VCD) Player, Audio Compact Disk (ACD) Player and/or Recorder, MP3 Player and CDR/CD-RW or a combination apparatus thereof.

Alternatively, a DVD Player, a VCD Player, an Audio CD Player and/or recorder, an MP3 Player or a CDR/CD-RW may also be housed separately or in selective combination in the device as desired and based on the requirement and use.

The external disk may be a conventional storage disk such as a compact disk, a laser disk, a Digital Video Disk or substantially similar such existing and future versions of external storage disks.

The internal storage unit may be a hard disk or a memory chip for storing video and digital data.

In one preferred embodiment of the present invention (see FIG. 1), the projector module (2) is located at the upper part of the housing (1) while the data module (3) is located at the lower part of the housing (1) such that the projector module (2) and the data module (3) are stacked along the vertical direction.

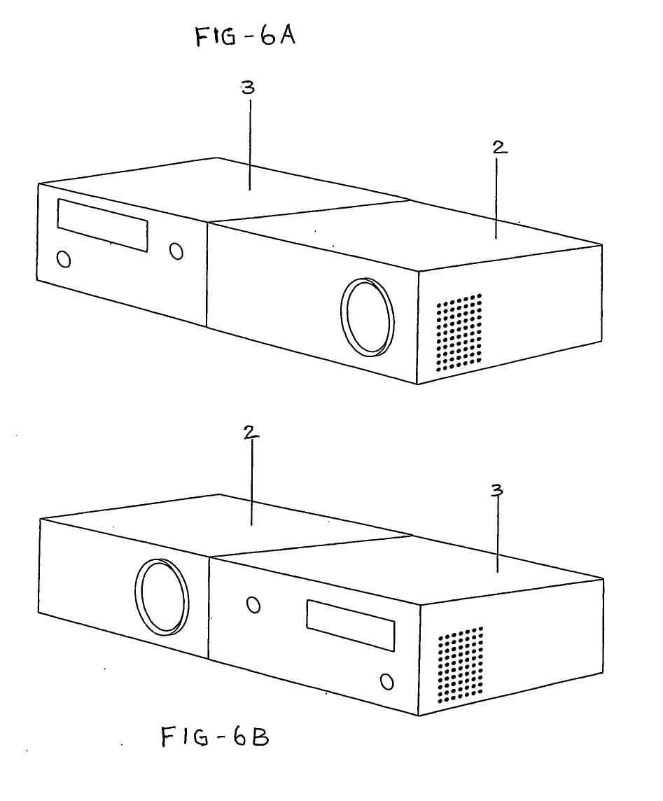

In another embodiment, the projector module (2) is located beside the data module (3) as shown in FIG. 6A, in which case the height of the cabinet housing (1) is apparently reduced while the width of the housing (1) is increased.

According to further embodiment of the present invention, the projector module (2) is located preferably at the left hand side of the data module (3) as shown in FIG. 6B.

The position of the projector module (2) and the data module (3) may be further altered say for example the projector module (2) and the data module (3) may be arranged in a back-to-back configuration.

All such modifications and positional arrangements of the projector module (2) and the data module (3) are for the sake of convenience in storage and use of the device and are well contemplated and deemed to be within the scope this invention.

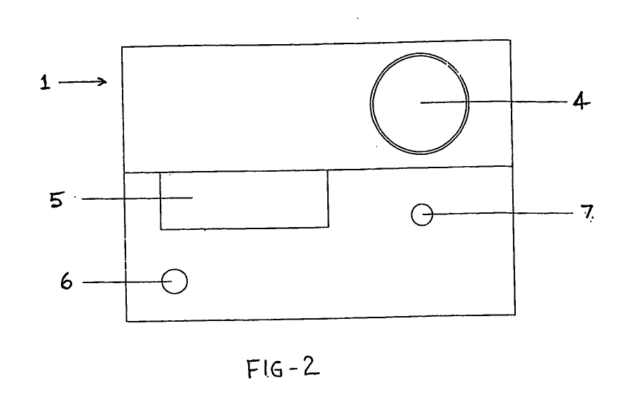

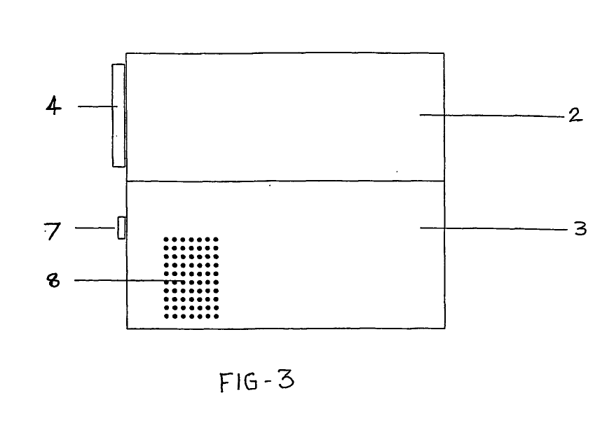

FIG. 2 & FIG. 3. The housing (1) comprises an opening preferably at the front panel (11) for mounting a lens front (4) of the projector module (2). Another opening is provided at the front panel (11) of the housing (1), for mounting the combo-drive unit (5). A button (6) for switching ON and OFF of the device, according to a preferred embodiment of the present invention, is mounted at a location adjacent to or below the combo-drive unit (5) within the front panel (11) of the housing (1). A knob (7) for volume control is preferably mounted on the front panel (11) at a location suitable for convenient operation by the user.

The positional arrangement of the lens front (4), combo-drive unit (5) and knob (7) as described in the foregoing description is meant for easy accessibility and use of the device by the user. The above positional arrangement may be modified according to the requirement of the individuals. Referring to FIG. 3, a pair of speaker grills (8) of an audio amplifier circuit (not illustrated) is mounted one on each side wall of the housing (1). The audio amplifier circuit is operable in conjunction with the sub-assemblies.

FIG. 4. Preferably, the rear panel (12) of the housing (1) comprises one or more ports (13) for connecting to external peripheral devices such as remote keyboard, camera, printer, scanner, etc. for use along with the device as desired. A plurality of ports (14), (15) & (16) are provided at the rear panel (12) for respectively connecting to a network such as LAN and internet source, and input such as RF input for receiving TV signals through cable/antenna. A power socket (17) is preferably provided at the rear panel (12) of the housing (1) for connecting to an electrical power source.

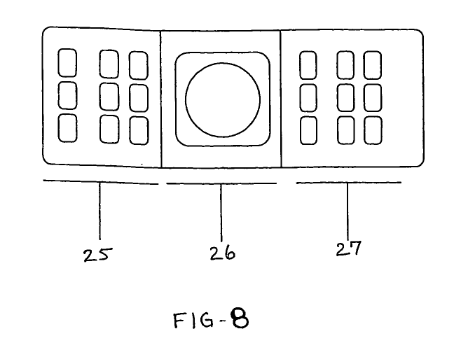

A common remote control (as illustrated in FIG. 8) may be fully or partly incorporated for remote operation of the device.

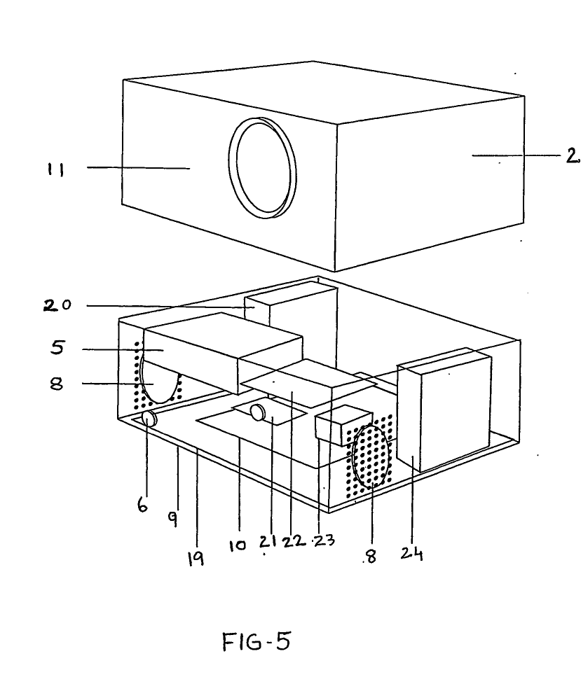

FIG. 5. Illustrates the arrangement of various sub-assemblies associated with the device according to the present invention. The data module (3) comprises a base (18) mounted with a chassis (19) on the inner side. Within the data module (3), a motherboard (10), an audio amplifier card (21), a TV tuner card (22), a CPU (23), a hard disk (24) and a Power supply (20) are mounted. The TV tuner card (22) is capable of receiving a plurality of television signal data. All the sub-assemblies of the device are internally preconnected so as to be operated by a single ON-OFF button (6).

A common power supply (20) supplies electric power to the projector module (2), the TV-Tuner card (22), the audio amplifier card (21) and the speakers (8), the motherboard (10) and the CPU (23), the hard disk (24) and the combo-drive (5). The entire unit is switched on by activating the ON-OFF button (6) on the anterior end of the housing (1). The RGB signals of the processed data from both the computer unit and the TV tuner are connected to the RGB input of the projector module (2), making the projector module capable of displaying both the TV and the PC data.

A remote control (see FIG. 8) for operation of the device comprises a set of controls (25) for projector operation, control (26) for computer operation, control (27) for television, all combined in one unit.

The TV tuner card (22) is connected to external TV signals via a cable connection on the rear panel (12), for receiving terrestrial TV broadcast signals through an antenna cable, or cable TV signals through a subscribed cable connection.

The PC unit comprising the CPU (23) is connected to the internal hard disk (24) for storing the system software, application programmes and content. External data can be input through the combo-drive (5) in the form of DVDs, VCDs and CDs allowing viewing of data as well as loading of application programmes. The CD write function of the combo drive (5) allows processed data to be written on an external disc for data transfer.

The ports (14, 15, 16) provided on the posterior of the device allow connectivity for various functions as and when required. For example, a number of USB/Firewire (IEEE 1394) ports allow various devices (such as wireless receiver, keyboard, scanner, printer, camera, etc. to be connected. The Ethernet port (14) allows sharing of files with other computer on the network or to connect to internet through a cable connection. The modem port (15) provides connectivity to the internet and the World Wide Web through a telephone line. The TV cable port provides connectivity to incoming signals either through an antenna cable or through subscription cable service.

The unit can be set to work in either TV or in PC mode through the use of a remote control, as well as with the controls provided the audio volume.

In the TV mode, the projector displays the incoming TV signals, with channel selection by the remote controls, which also controls the audio volume.

When used in the PC mode, the projector projects the output of the processed video signal from the PCT in a large format on any plain surface.

The device can be switched from TV to the PC mode anytime during the normal working of the device, enabling the user to switch between the TV and PC functions at will.

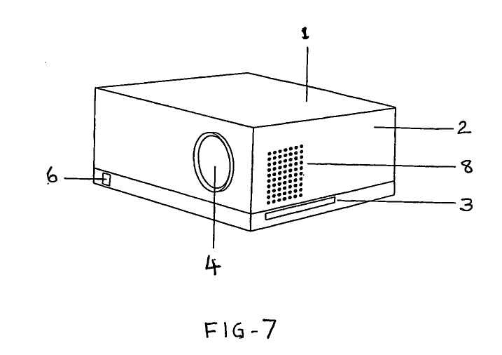

FIGS. 7 and 8. In a further embodiment, the device has all the sub-assemblies such as the projector module (2), speaker grill (8), data module (3) with combo-drive (5), lens front (4) of the projector module (2), ON-OFF switch (6), all configured in miniature form and size to make the entire device compact enough as desired.

It will be noted in this connection that, in order to remedy the disadvantages of the sections of the prior art, the applicant is acting contrary to what this known art was teaching, since whereas apparatus such as projectors, television, internet enabled computer, CD Player, DVD Player and so on have always been employed in the art for community learning, data transmission, entertainment purposes, either individually or in combination with one or more devices such as a television and a computer, computer and a projector, television and CD Player within a common housing or as an externally connected cluster of one or more of the abovementioned devices, the applicant proposes to principally employ the convergence of apparatus (referred to as sub-assemblies in this application) viz., the projector, the combo-drive unit, the internet enabled computer, the television, and an internal storage unit such as hard disk, within one compact and portable housing wherein the sub-assemblies are preconnected such that the device is suitable for and extremely easy to use in community learning, data transmission, entertainment and public governance.

Thus, while there have been shown and described and pointed out fundamental novel features of the present invention as applied to preferred embodiments thereof, it will be understood that the described embodiments are to be considered in all respects only as illustrative and not restrictive and various omissions, substitutions and changes in the form and details of the methods described may be made by those skilled in the art without departing from the spirit of the present invention. For example, it is expressly intended that all combinations of those elements and/or method steps which perform substantially the same function in substantially the same way to achieve the same results are within the scope of the invention. Substitutions of elements from one described embodiment to another are also fully intended and contemplated. It is the intention, therefore, to be limited only as indicated by the scope of the claims appended hereto. All changes which come within the meaning and range of equivalency of the claims are to be embraced within their scope.

1. A portable, integrated, electronic, interactive device for community learning, data transmission, entertainment, and public governance comprising:
(a) a housing
(b) said housing accommodating a plurality of sub-assemblies
(c) said sub-assemblies including:
i. a computational circuit for generating, receiving, processing, and data input through an input device and adapted to be connected to a network, as well as various digital data communication devices; and
ii. a recording device for recording, reproducing and storing audio, video and/or digital data onto and/or from an external disk and an internal storage unit coupled to said computational circuit;
iii. a television tuner card coupled to said recording device and adapted to receive a plurality of television signal data;
iv. a projecting device for projecting video and digital data into a predetermined ultra large size image over a surface external to the housing; coupled to said recording device, computational circuit and television tuner card;
wherein said sub-assemblies are in pre-connected relationship with each other whereby the device is extremely compact, portable and easy to use.

2. The device according to claim 1 wherein the housing further comprises an audio amplifier circuit operable in conjunction with the sub-assemblies.

3. The device according to claim 1 wherein the sub-assemblies are operable by a single ON-OFF switch.

4. The device according to claim 1 wherein the housing comprises a front panel and a rear panel and/or the sub-assemblies are operated by an ON-OFF switch located at the front panel of the housing.

5. The device as claimed in claim 1 wherein the computational circuit is preferably a multimedia computer.

6. The device according to claim 1 wherein the recording device for recording, reproducing and storing audio, video and/or digital from an external disk is an audio CD player, a VCD player, a DVD player, an MP3 player, a CD-R/CD-RW or a combination apparatus thereof.

7. The device according to claim 1 combined with an ultra large size display and wherein the size of the ultra large size display is preferably in the range of about 21 inches to about 300 inches diagonal measure.

8. The device according to claim 1 wherein the housing comprises a plurality of ports at the rear panel for connecting the device to a network, input for receiving television signals through cable or antenna.

9. The device according to claim 1 wherein a common power supplies power to the sub-assemblies; and/or a remote control is used to control the operation of the sub-assemblies.

10. The device according to claim 1 wherein the sub-assemblies (ii), (iii) and (iv) are configured as a first module and the sub-assembly (i) is configured as a second module.

11. The device according to claim 10 wherein:
the first module is a data module; and/or
the second module is a projection module; and/or
the first module is located adjoining above or besides the second module; and/or
the first module and the second module are arranged in back-to-back adjoining configuration.
